(19) United States
(12) Patent Application Publication
(10) Pub. No.: US 2014/0279000 A1
(43) Pub. Date: Sep. 18, 2014

(54) SYSTEM AND METHOD FOR AUTOMATICALLY CONFIGURING A WEBPAGE TO DISPLAY A GEOGRAPHICALLY FOCUSED INTERNET OFFERING

(71) Applicant: Google Inc., Mountain View, CA (US)

(72) Inventors: Arnold BINAS, Kirribilli (AU); Grim Hegland IVERSEN, Manly (AU); Jordan John BAYLISS-MCCULLOCH, Beaconsfield (AU); Michael PERROW, Pyrmont (AU)

(73) Assignee: Google Inc., Mountain View, CA (US)

(21) Appl. No.: 13/831,416

(22) Filed: Mar. 14, 2013

(51) Int. Cl. G06Q 30/02

(52) U.S. Cl. CPC G06Q 30/0259
USPC 705/14.57

(57) ABSTRACT

A system and method is disclosed for automatically configure a webpage to display a geographically focused internet offering. An interactive map is configured to, when displayed in a web browser, automatically detect one or more online marketing components associated with a currently displayed webpage. On an initial display or user-repositioning of the interactive map, the map transmits a geographic location displayed on the map to the marketing components. Each marketing component then displays one or more offerings related to the displayed area of interest.

### TECHNICAL FIELD

The subject technology relates generally to the display of websites, namely systems for displaying advertisements in website components.

### BACKGROUND

A website may be integrated with an interactive internet map that provides a user with the ability to view geographic information. The interactive map may be rendered within a computer-enabled interactive viewport that comprises a region of the display, and that functions to display a portion of the map at any one time. The website may also be configured with one or more marketing components that dynamically display advertisements based on predetermined user interests. For example, information may be gathered about a user's interests (for example, with the user's permission) and stored in connection with the storage of one or more HTTP Cookies on a web browser. Those interests may then be retrieved and used by the online marketing component to generate the one or more offerings.

### SUMMARY

The subject technology provides a system and method for automatically configure a webpage to display a geographically focused internet offering. According to one aspect, a computer-implemented method may include providing, using one or more computing devices, an interactive map for display in connection with a currently displayed website, automatically detecting one or more online marketing components associated with the currently displayed website, the one or more marketing components being separated from the interactive map and configured to display one or more offerings based on a geographic information, on an initial display or user-repositioning of the interactive map, providing, to at least one of the one or more marketing components, using the one or more computing devices, geographic information for an area of interest displayed on the interactive map, and displaying, by the at least one marketing component, one or more offerings related the area of interest displayed on the interactive map.

In another aspect, a machine-readable medium may include instructions stored thereon that, when executed, cause a machine to perform a method of displaying a geographically focused internet offering. In this regard, the method may include providing a marketing component to a webpage, the marketing component configured to display, in a web browser, one or more offerings related to the webpage and, when available, geographic information, automatically detecting an interactive map displayed in connection with the webpage, receiving from the interactive map, on an initial display or user-repositioning of the interactive map, geographic information related to an area of interest displayed on the interactive map, and displaying, on the currently displayed webpage, one or more offerings related to the area of interest.

In a further aspect, a system according to the subject technology may include one or more first processors and a first memory. The first memory may include first server instructions thereon that, when executed, by the one or more first processors, cause map instructions to be provided to a web browser located on a client device. In this regard, the map instructions, when executed by the client device, may cause the client device to display an interactive map on a currently displayed webpage, automatically detect the presence of one or more online marketing components displayed by the currently displayed webpage, and, on an initial display or user-repositioning of the interactive map, provide, to the one or more online marketing components, an area of interest displayed on the interactive map. The system may also include one or more second processors and a second memory. The second memory may include second server instructions thereon that, when executed, by the one or more first processors, provide the one or more online marketing components for display at the client device in connection with a request by the currently displayed webpage to display the one or more online marketing components. The one or more online marketing components, when displayed by the client device, may be configured to cause the client device to receive the area of interest displayed on the interactive map, determine one or more offerings based on the geographic information based on one or more focusing signals and the area of interest displayed on the interactive map, and provide the one or more offerings for display in connection with the currently displayed webpage.

It is understood that other configurations of the subject technology will become readily apparent to those skilled in the art from the following detailed description, wherein various configurations of the subject technology are shown and described by way of illustration. As will be realized, the subject technology is capable of other and different configurations and its several details are capable of modification in various other respects, all without departing from the scope of the subject technology. Accordingly, the drawings and detailed description are to be regarded as illustrative in nature and not as restrictive.

### BRIEF DESCRIPTION OF THE DRAWINGS

A detailed description will be made with reference to the accompanying drawings:

FIG. 1 depicts an exemplary webpage, displayed by a web browser, including an interactive Internet map one or more marketing components according to one aspect of the subject technology.

FIG. 2 is an diagram of exemplary components for automatically configuring a webpage to display a geographically focused internet offering according to one aspect of the subject technology.

FIG. 3 is a flowchart illustrating a process for automatically configuring a webpage to display a geographically focused internet offering according to one aspect of the subject technology.

FIG. 4 is an exemplary diagram of a client-server system, including a user interface for automatically configuring a webpage to display a geographically focused internet offering, according to one aspect of the subject technology.

FIG. 5 is a diagram illustrating a computing device for automatically configuring a webpage to display a geographically focused internet offering, including a processor and other internal components, according to one aspect of the subject technology.

### DETAILED DESCRIPTION

FIG. 1 depicts an exemplary webpage 101, displayed by a web browser 102, including an interactive Internet map 103 and one or more marketing components 104 according to one aspect of the subject technology. A marketing component 104 may comprise programming instructions (for example, JavaScript or other scripting code) inserted into the code that generates webpage 101. Each time the page is visited, the programming instructions may send information to a remote server call and retrieve marketing content via a series of procedural calls from webpage 101. The marketing content may include one or more offerings (for example, online advertisements, offers, coupons, or the like) for display in connection with the currently displayed webpage. Information passed to the remote server to generate the marketing content may include certain keywords, for example, programmed by the creator of webpage 101 to describe the content of webpage 101, services provided by it, or an interaction with a user. In one aspect, the subject technology enables marketing component 104 to determine one or more offerings for display by marketing component 104 based on geographic information received from interactive map 103. In this regard, offerings presented to a user may be related (for example, narrowed) by the geographic area of interest to the user.

Interactive map 103 may be provided in a viewport 105 displayed on webpage 101, separated from marketing components 104. The term “viewport” as used herein encompasses its plain and ordinary meaning, including, but not limited to, a rectangular geographic region of an interactive map that is visible at any one time, a section of programming instructions integrated with a webpage (for example, webpage 101) that, when executed by a web browser, displays a fraction of an interactive map, and/or the like. The operations of viewport 105 or an associated interactive map are unrelated to whether or not a marketing component is operating on the same website, or vice versa. Interactive map 103 may initially display a geographic area associated with information displayed on the webpage, or a stored user interest, and may then be manually repositioned by the user as a result of, for example, a dragging, panning, or zooming action. In other aspects, the interactive map may be automatically repositioned. For example, interactive map 103 may be displayed on a GPS-enabled device (for example, a smart phone or navigation unit) that updates the map in real-time as the device is moved in three-dimensional space. Viewport 105 may be capable of dynamically re-rendering interactive map 103 as a user selectively pans the map within the viewport, and sending information to marketing component 104 based on portion(s) of the interactive map displayed in viewport 105 when the viewport is updated. As depicted by FIG. 1, marketing components 104 may be responsible for generating and updating offerings displayed outside viewport 105 when the viewport is updated.

FIG. 2 is an diagram of exemplary components for automatically configuring a webpage to display a geographically focused internet offering according to one aspect of the subject technology. A user 200 may navigate to a webpage that includes a map viewport 201 (for example, viewport 105) and a marketing component 202 (for example, marketing component 104). Map viewport 201 may display a portion of an interactive internet map (for example, interactive map 103) that may be manipulated by user 200. Map viewport 201 may further be in operable communication with a map server 203, which may receive one or more coordinates from map viewport 201, process a user-manipulation of the map, and provide an updated portion of the map to map viewport 201.

Marketing component 202 may provide information about itself to other components of the webpage, including, for example, types of offerings displayed, the marketing component's virtual location on the webpage (for example, top, bottom, side), and the like. In one example, marketing component may provide the information through the exposing of one or more (public) functions or global parameters. In one aspect, map viewport 201 may be configured to automatically detect the presence of marketing component 202 by detecting and/or analyzing global parameters exposed by online marketing component 202. Likewise, marketing component 202 may be configured to automatically detect the presence of map viewport 201 by detecting and/or analyzing global parameters exposed by map viewport 201.

Map viewport 201 and marketing component 202 may then be automatically placed in operable communication with each other, for example, via a series of function calls between map viewport 201 and marketing component 202. In one aspect, where multiple marketing components are displayed on a webpage, map viewport 201 may be placed in communication with a marketing component that is selected based on position information provided by the marketing components. For example, instructions provided in connection with map viewport 201 may determine which of the multiple marketing components is nearest to map viewport 202 (and, for example, the interactive map) and communicate with that component. Once map viewport 201 and marketing component 202 are placed in communication with each other, marketing component 202 may receive map information from the interactive map, for example, via the previously described global parameters or function calls, or by subscribing to viewport updates from the map component.

On an initial display or user-repositioning of the interactive map, map instructions may transmit geographic information to one or more online marketing components located on the currently displayed webpage. In one aspect, the geographic information may be based on an area of interest displayed on the interactive map. The area of interest may, for example, be represented as one or more coordinates, such as latitude and longitude coordinates and/or altitude information, GPS position information, cartography data, or the like. In this regard, marketing component 202 may be in operable communication with a marketing server 206 responsible for the generation of content for display by marketing component 202. Marketing component 202 may receive the geographic information from map viewport 201 and pass (for example, send, transmit, make available, or the like) the geographic information as one or more parameters to marketing server 206 along with other parameters.

Marketing server 206 may display one or more offerings based on the previously described geographic information, as well as other focusing signals. For example, focusing signals may include the content or category (for example, type of services provided) of a currently viewed web page, predetermined search terms associated with a displayed region of the map, a geographic location derived from an IP address, or the like. The focusing signals may be used to determine a candidate set of offerings (for example, selected based on the focusing signals), and then the candidate set may be narrowed by the received geographic information. In one example, one or more offerings may be determined based on a predetermined user interest. Predetermined user interests may be derived from, for example, previous websites visited, internet searches made through a search engine and the like, and then stored, upon the discretion of the user, in one or more cookies, in a centralized storage (for example, a data cloud), or the like. In this regard, marketing server 206 may be integrated with a user account 207 of user 200. If the user has opted-in to the storage of marketing preferences, information pertaining to one or more interests of the user may be privately stored in connection with user account 207. On user 200 authenticating to user account 207, the information may be used as one or more parameters by marketing server 206 in determining one or more offerings to return to marketing component 202 for display to user 200. Marketing server 206 may then index the centralized storage by the received parameters to retrieve one or more offerings related to the parameters. Once marketing component 202 receives the selection of offerings from marketing server 206, marketing component 203 may display, on the currently displayed webpage, the one or more offerings to user 200.

FIG. 3 is a flowchart illustrating a process for automatically configuring a webpage to display a geographically focused internet offering according to one aspect of the subject technology. In block 301, an interactive map 103 is provided for display in connection with a currently displayed website. The interactive map may be provided by one or more server computing devices, including map server 203 or marketing server 206. User 200 may navigate a web browser 102 of a client computing device to a website hosted by the one or more server computing devices. In this respect, the interactive map may be displayed in a map viewport 201 on a webpage 101, together with one or more marketing components 202. The one or more marketing components 202 may be separated from, or embedded within, map viewport 201. In some aspects, the marketing components may be provided to the webpage by a different computing device than the computing device which provides the interactive map. The one or more marketing components are configured to display one or more offerings based on geographic information.

In block 302, the one or more online marketing components associated with the currently displayed website are automatically detected (for example, by the instructions associated with the interactive map). In some aspects, one or more online marketing components 202 may be detected by map viewport 201. Instructions provided with map viewport 201 may detect a component by automatically detecting the presence of one or more global parameters exposed by the component. In other aspects, the one or more marketing components may be detected by instructions executing in connection with the currently displayed webpage (for example, on map server 203), or instructions embedded within web browser 102.

In block 303, an indication that the interactive map was initially displayed or repositioned may be received. The indication may be received, for example, at the website or the one or more server computing devices. In some implementations, the map is repositioned on a pan or zoom operation performed by user 200. In other implementations, where the client computing device is a mobile device the map may be updated in real-time as the device is moved in three-dimensional space.

In block 304, on the initial display or user-repositioning of the interactive map, geographic information for an area of interest displayed on the interactive map is provided to at least one of the one or more marketing components. Whether a marketing component 202 receives the geographic information is based on selection criteria such as the position of the marketing component relative to viewport 201, configuration information or meta data embedded into the marketing component or currently displayed webpage, or the like. For example, position information may be obtained by viewport 201 for all marketing components on the currently displayed webpage, and the geographic information sent to the marketing component closest to the viewport, or located at a predetermined position on the webpage.

In block 305, at least one marketing component displays one or more offerings related the area of interest displayed on the interactive map. Accordingly, in some implementations, a selected marketing component 202 receives and transmits the geographic information to marketing server 206. Marketing server 206 may authenticate to, or confirm the presence of, user account 207. Marketing server 206 may then determines the one or more offerings based on the geographic information and, in some implementations, marketing preferences stored in connection with user account 207. The offerings are then returned to the selected marketing component for display to user 200.

FIG. 4 is an exemplary diagram of a client-server system, including a user interface for automatically configuring a webpage to display a geographically focused interne offering, according to one aspect of the subject technology. In some aspects, the subject technology may include a marketing server 401 (or group of servers) in communication with a marketing database 402 (for example, for storing online offerings). Marketing server 401 and marketing database 402 may be connected to and/or communicate with each other via a private local area network (or wide area network). Marketing server 401 may be further connected via the Internet 403 to a client device 404 (for example a personal computer, tablet computer, PDA, Smartphone, a television or other display device with one or more computing devices embedded therein or attached thereto, or the like). In further aspects, the system may also include a map server 405 (or group of servers) in communication with a map database 406 (for example, for storing map-related information). Map server 405 and map database 406 may be connected to and/or communicate with each other via a remote private LAN/WAN. Likewise, in one aspect, marketing server 401 and map server 405 may be connected to and/or communicate with each other via the remote private LAN/WAN or Internet 403. In some aspects, the various connections between marketing server 401, client device 404, map server 405, and/or the Internet or private LAN/WAN may be made over a wired or wireless connection. In some aspects, the functionality of marketing server 401 and map server 405 may be implemented on the same physical server or distributed among a plurality of servers. Similarly, the functionality of marketing database 402 and map database 406 may be implemented in the same database or distributed across a plurality of databases. Moreover, the databases may take any form such as relational databases, object-oriented databases, file structures, text-based records, or other forms of data repositories.

Marketing server 401 and/or map server 405 may be configured to communicate with a user interface 407 (for example, a webpage displayed in a web browser) on client device 404. In this aspect, user interface 407 may be configured to (for example, in connection with viewing a webpage) display to a user 409 an interactive geographic representation 408 (for example, interactive map 103 or the like) received from map server 405. Likewise, user interface 407 may also be configured to display (for example, on panel 205) one or more marketing components 510 (for example, marketing components 104 or 202) for the display of one or more online offerings along a side of interactive geographic representation 408, or to superimpose the offerings on the interactive map (for example, in the form of icons and/or text).

In one aspect, a first communication channel 411 is made between marketing server 401 and user interface 407 to convey content information (for example, the one or more offerings) to marketing components 410. First communication channel 411 may be uni-directional, or bi-directional in that it may, for example, also receive parameters from user interface 407 (for example, to facilitate the selection of offerings to display). A second communication channel 412 may be made between map server 405 and user interface 407 to convey geographic representation 408 or portion thereof to user interface 407 (for example, to be displayed by a map viewport 201). Second communication channel 412 may be uni-directional, or bi-directional in that it may, for example, also receive selections made by user 409 in relation to user interface 407 and/or interactive geographic representation 408 (for example, on a user-repositioning of an interactive map). The user selections and/or parameters provided by marketing component 410 may be sent by user interface 407 using HTTP request/response, XMLHttpRequest (XHR), or the like.

In one aspect, user interface 407 may be a webpage or website viewed in a web browser, and displaying interactive geographic representation 408 may include redirecting a region of the browser (for example, viewport 105) to another location responsible for displaying interactive geographic representation 408. Redirection may be by domain redirection, a GET or POST command, and/or the like. In some aspects, geographic location data (for example, coordinates) may be sent to and from map server 405 in connection with displaying and/or interacting with interactive geographic representation 408 at user interface 407, for example, as the result of user 409 panning an interactive map.

FIG. 5 is a diagram illustrating a computing device for automatically configuring a webpage to display a geographically focused internet offering, including a processor and other internal components, according to one aspect of the subject technology. In some aspects, a computing device 500 (for example, server 203 or 206, client device 404, server 401 or 405, or the like) may include several internal components such as a processor 501, a system bus 502, read-only memory 503, system memory 504, network interface 505, I/O interface 506, and the like. In one aspect, processor 501 may also be communication with a storage medium 507 (for example, a hard drive, database, or data cloud) via I/O interface 506. In some aspects, all of these elements of device 500 may be integrated into a single device. In other aspects, these elements may be configured as separate components.

Processor 501 may be configured to execute code or instructions to perform the operations and functionality described herein, manage request flow and address mappings, and to perform calculations and generate commands. Processor 501 is configured to monitor and control the operation of the components in server 500. The processor may be a general-purpose microprocessor, a microcontroller, a digital signal processor (DSP), an application specific integrated circuit (ASIC), a field programmable gate array (FPGA), a programmable logic device (PLD), a controller, a state machine, gated logic, discrete hardware components, or a combination of the foregoing. One or more sequences of instructions may be stored as firmware on a ROM within processor 501. Likewise, one or more sequences of instructions may be software stored and read from ROM 503, system memory 504, or received from a storage medium 507 (for example, via I/O interface 506). ROM 503, system memory 504, and storage medium 507 represent examples of machine or computer readable media on which instructions/code may be executable by processor 501. Machine or computer readable media may generally refer to any medium or media used to provide instructions to processor 501, including both volatile media, such as dynamic memory used for system memory 504 or for buffers within processor 501, and non-volatile media, such as electronic media, optical media, and magnetic media.

In some aspects, processor 501 is configured to communicate with one or more external devices (for example, via I/O interface 506). Processor 501 is further configured to read data stored in system memory 504 and/or storage medium 507 and to transfer the read data to the one or more external devices in response to a request from the one or more external devices. The read data may include one or more web pages and/or other software presentation to be rendered on the one or more external devices. The one or more external devices may include a computing system such as a personal computer, a server, a workstation, a laptop computer, PDA, smart phone, and the like.

In some aspects, system memory 504 represents volatile memory used to temporarily store data and information used to manage device 500. According to one aspect of the subject technology, system memory 504 is random access memory (RAM) such as double data rate (DDR) RAM. Other types of RAM also may be used to implement system memory 504. Memory 504 may be implemented using a single RAM module or multiple RAM modules. While system memory 504 is depicted as being part of device 500, those skilled in the art will recognize that system memory 504 may be separate from device 500 without departing from the scope of the subject technology. Alternatively, system memory 504 may be a non-volatile memory such as a magnetic disk, flash memory, peripheral SSD, and the like.

I/O interface 506 may be configured to be coupled to one or more external devices, to receive data from the one or more external devices and to send data to the one or more external devices. I/O interface 506 may include both electrical and physical connections for operably coupling I/O interface 506 to processor 501, for example, via the bus 502. I/O interface 506 is configured to communicate data, addresses, and control signals between the internal components attached to bus 502 (for example, processor 501) and one or more external devices (for example, a hard drive). I/O interface 506 may be configured to implement a standard interface, such as Serial-Attached SCSI (SAS), Fiber Channel interface, PCI Express (PCIe), SATA, USB, and the like. I/O interface 506 may be configured to implement only one interface. Alternatively, I/O interface 506 may be configured to implement multiple interfaces, which are individually selectable using a configuration parameter selected by a user or programmed at the time of assembly. I/O interface 506 may include one or more buffers for buffering transmissions between one or more external devices and bus 502 and/or the internal devices operably attached thereto.

Those of skill in the art would appreciate that the various illustrative blocks, modules, elements, components, methods, and algorithms described herein may be implemented as electronic hardware, computer software, or combinations of both. To illustrate this interchangeability of hardware and software, various illustrative blocks, modules, elements, components, methods, and algorithms have been described above generally in terms of their functionality. Whether such functionality is implemented as hardware or software depends upon the particular application and design constraints imposed on the overall system. Skilled artisans may implement the described functionality in varying ways for each particular application. Various components and blocks may be arranged differently (e.g., arranged in a different order, or partitioned in a different way) all without departing from the scope of the subject technology.

It is understood that the specific order or hierarchy of steps in the processes disclosed is an illustration of exemplary approaches. Based upon design preferences, it is understood that the specific order or hierarchy of steps in the processes may be rearranged. Some of the steps may be performed simultaneously. The accompanying method claims present elements of the various steps in a sample order, and are not meant to be limited to the specific order or hierarchy presented.

The previous description is provided to enable any person skilled in the art to practice the various aspects described herein. The previous description provides various examples of the subject technology, and the subject technology is not limited to these examples. Various modifications to these aspects will be readily apparent to those skilled in the art, and the generic principles defined herein may be applied to other aspects. Thus, the claims are not intended to be limited to the aspects shown herein, but is to be accorded the full scope consistent with the language claims, wherein reference to an element in the singular is not intended to mean “one and only one” unless specifically so stated, but rather “one or more.” Unless specifically stated otherwise, the term “some” refers to one or more. Pronouns in the masculine (e.g., his) include the feminine and neuter gender (e.g., her and its) and vice versa. Headings and subheadings, if any, are used for convenience only and do not limit the invention.

The term website, as used herein, may include any aspect of a website, including one or more web pages, one or more servers used to host or store web related content, and the like. Accordingly, the term website may be used interchangeably with the terms web page and server. The predicate words “configured to”, “operable to”, and “programmed to” do not imply any particular tangible or intangible modification of a subject, but, rather, are intended to be used interchangeably. For example, a processor configured to monitor and control an operation or a component may also mean the processor being programmed to monitor and control the operation or the processor being operable to monitor and control the operation. Likewise, a processor configured to execute code can be construed as a processor programmed to execute code or operable to execute code.

A phrase such as an “aspect” does not imply that such aspect is essential to the subject technology or that such aspect applies to all configurations of the subject technology. A disclosure relating to an aspect may apply to all configurations, or one or more configurations. An aspect may provide one or more examples. A phrase such as an aspect may refer to one or more aspects and vice versa. A phrase such as an “embodiment” does not imply that such embodiment is essential to the subject technology or that such embodiment applies to all configurations of the subject technology. A disclosure relating to an embodiment may apply to all embodiments, or one or more embodiments. An embodiment may provide one or more examples. A phrase such as an “embodiment” may refer to one or more embodiments and vice versa. A phrase such as a “configuration” does not imply that such configuration is essential to the subject technology or that such configuration applies to all configurations of the subject technology. A disclosure relating to a configuration may apply to all configurations, or one or more configurations. A configuration may provide one or more examples. A phrase such as a “configuration” may refer to one or more configurations and vice versa.

The word “exemplary” is used herein to mean “serving as an example or illustration.” Any aspect or design described herein as “exemplary” is not necessarily to be construed as preferred or advantageous over other aspects or designs.

All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. §112, sixth paragraph, unless the element is expressly recited using the phrase “means for” or, in the case of a method claim, the element is recited using the phrase “step for.” Furthermore, to the extent that the term “include,” “have,” or the like is used in the description or the claims, such term is intended to be inclusive in a manner similar to the term “comprise” as “comprise” is interpreted when employed as a transitional word in a claim.

What is claimed is:

1. A computer-implemented method for automatically configuring a webpage to display a geographically focused interne offering, comprising:
providing, using one or more computing devices, an interactive map for display in connection with a currently displayed website;
automatically detecting one or more online marketing components associated with the currently displayed website, the one or more marketing components being separated from the interactive map and configured to display one or more offerings based on geographic information;
on an initial display or user-repositioning of the interactive map, providing, to at least one of the one or more marketing components, using the one or more computing devices, geographic information for an area of interest displayed on the interactive map; and
displaying, by the at least one marketing component, one or more offerings related the area of interest displayed on the interactive map.

2. The computer-implemented method of claim 1, further comprising:
determining, by instructions associated with the one or more marketing components, the one or more offerings based on the geographic information.

3. The computer-implemented method of claim 1, wherein the interactive map is provided to a web browser in connection with a request by the currently displayed website to display the interactive map.

4. The computer-implemented method of claim 1, wherein the one or more marketing components are provided to a web browser in connection with a request by the currently displayed website to display the one or more marketing components.

5. The computer-implemented method of claim 2, further comprising:
providing, from one or more server devices, the one or more marketing components to a web browser that is currently displaying the currently displayed website.

6. The computer-implemented method of claim 1, wherein the automatically detecting one or more marketing components comprises:
the interactive map automatically detecting the presence of one or more global parameters exposed by the marketing component.

7. The computer-implemented method of claim 1, wherein the interactive map is displayed on a location-aware device, the method further comprising:
updating the map in real-time as the device is moved in three-dimensional space.

8. The computer-implemented method of claim 1, wherein the at least one marketing component is selected from multiple marketing components displayed on the currently displayed website based on position information provided by the one or more marketing components.

9. The computer-implemented method of claim 8, wherein the at least one marketing component is selected because it is displayed closer to the interactive map than one or more other marketing components.

10. The computer-implemented method of claim 1, wherein the geographical information includes one or more geographic coordinates associated with the area of interest.

11. The computer-implemented method of claim 1, wherein the area of interest geographically narrows a selection of offerings determined from one or more focusing signals.

12. A machine-readable medium having instructions stored thereon that, when executed, cause a machine to perform a method of displaying a geographically focused internet offering, the method comprising:
providing a marketing component to a webpage, the marketing component configured to display, in a web browser, one or more offerings related to the webpage and, when available, geographic information;
automatically detecting an interactive map displayed in connection with the webpage;
receiving from the interactive map, on an initial display or user-repositioning of the interactive map, geographic information related to an area of interest displayed on the interactive map; and
displaying, on the currently displayed webpage, one or more offerings related to the area of interest.

13. The machine-readable medium of claim 11, wherein the automatically detecting the interactive map comprises:
the marketing component detecting the presence of one or more functions exposed by the interactive map.

14. The machine-readable medium of claim 11, wherein the webpage is displayed on a location-aware device, the method further comprising:
updating the interactive map in real-time as the location-aware device is moved in three-dimensional space.

15. The machine-readable medium of claim 11, the method further comprising:
on the user-repositioning of the interactive map, geographically narrowing a selection of current offerings displayed by the marketing component based on the geographic information.

16. The computer-implemented method of claim 11, wherein the geographical information includes one or more geographic coordinates.

17. The computer-implemented method of claim 1, wherein the marketing component is further configured to display the one or more offerings based on one or more focusing signals, and wherein the displayed one or more offerings are related to at least one of the one or more focusing signals.

18. A system, comprising:
one or more first processors; and
a first memory, the first memory including first server instructions thereon that, when executed, by the one or more first processors, cause map instructions to be provided to a web browser located on a client device, the map instructions, when executed by the client device, facilitate causing the client device to:
display an interactive map on a currently displayed webpage,
automatically detect the presence of one or more online marketing components displayed by the currently displayed webpage, and
on an initial display or user-repositioning of the interactive map, provide, to the one or more online marketing components, an area of interest displayed on the interactive map.

19. The system of claim 18, further comprising:
one or more second processors; and
a second memory, the second memory including second server instructions thereon that, when executed, by the one or more first processors, provide the one or more online marketing components for display at the client device in connection with a request by the currently displayed webpage to display the one or more online marketing components, the one or more online marketing components, when displayed by the client device, configured to:
receive the area of interest displayed on the interactive map;
determine one or more offerings based on the geographic information based on one or more focusing signals and the area of interest displayed on the interactive map; and
provide the one or more offerings for display in connection with the currently displayed webpage.

20. The system of claim 18, wherein the map instructions are provided to the web browser in connection with a request by the currently displayed webpage to display the interactive map.
